(19) United States
(12) Patent Application Publication
(10) Pub. No.: US 2016/0086717 A1
(43) Pub. Date: Mar. 24, 2016

(54) MAGNETIC MATERIAL, METHOD FOR PRODUCING MAGNETIC MATERIAL, AND INDUCTOR ELEMENT

(71) Applicant: Kabushiki Kaisha Toshiba, Minato-ku (JP)

(72) Inventors: Koichi HARADA, Bunkyo (JP); Toshihide TAKAHASHI, Yokohama (JP); Tomohiro SUETSUNA, Kawasaki (JP); Tomoko EGUCHI, Yokohama (JP); Seiichi SUENAGA, Yokohama (JP)

(73) Assignee: Kabushiki Kaisha Toshiba, Minato-ku (JP)

(21) Appl. No.: 14/842,255

(22) Filed: Sep. 1, 2015

(30) Foreign Application Priority Data
Sep. 22, 2014 (JP) 2014-192176

(51) Int. Cl. H01F 27/255; H01F 41/02; H01F 1/20; H01F 1/147; C22F 1/10; C21D 1/00

(52) U.S. Cl. CPC H01F 27/255; C22F 1/10; C21D 1/00; H01F 1/20; H01F 1/14733; H01F 41/02

(57) ABSTRACT

Provided is a magnetic material which includes a plurality of magnetic metal particles having a rate of change in the lattice constant of ±1% or less with respect to the lattice constant obtained after a heat treatment at 1000° C., a plurality of insulating coating layers insulating and covering at least a portion of the magnetic metal particles, and an insulating resin disposed around the magnetic metal particles and the insulating coating layers. The insulating coating layers are in contact with one another.

### CROSS-REFERENCE TO RELATED APPLICATION

This application is based upon and claims the benefit of priority from Japanese Patent Application No. 2014-192176, filed on Sep. 22, 2014, the entire contents of which are incorporated herein by reference.

### FIELD

Embodiments described herein relate generally to a magnetic material, a method for producing a magnetic material, and an inductor element.

### BACKGROUND

In recent years, size reduction and weight reduction of electronic communication equipment is promoted along with a rapid increase in communication and information. Along with this trend, size reduction and weight reduction of electronic component parts is desirable.

Conventional high magnetic permeability materials are metals, alloys or oxides containing iron (Fe) and cobalt (Co) as components. Since metals or alloys bring about significant transfer losses caused by eddy currents at high frequencies, it is not preferable to use metals or alloys. On the other hand, if oxides represented by ferrites are used, since these substances have high resistance, the losses caused by eddy currents are suppressed. However, since the substances have resonance frequencies of several hundred MHz, significant transfer losses caused by resonance occur at high frequencies, and use of the substances is not preferable. Thus, there is a demand for an insulating, high magnetic permeability material with suppressed losses at a high frequency.

### BRIEF DESCRIPTION OF THE DRAWINGS

FIG. 1 is a schematic cross-sectional diagram of a magnetic material of a first embodiment.

FIGS. 2A to 2E are schematic diagrams illustrating a method for producing a magnetic material of the first embodiment.

FIG. 3 is a schematic cross-sectional diagram of a magnetic material of a second embodiment.

FIG. 4 is a schematic cross-sectional diagram of a magnetic material of a third embodiment.

FIG. 5 is a schematic diagram of a chip inductor element of a fourth embodiment.

FIGS. 6A and 6B are schematic diagrams of an inductor element for transformers of the fourth embodiment.

### DETAILED DESCRIPTION

### First Embodiment

A magnetic material according to the present embodiment includes a plurality of magnetic metal particles having a rate of change in the lattice constant of ±1% or less with respect to the lattice constant obtained after a heat treatment at 1000° C.; a plurality of insulating coating layers insulating and covering at least a portion of the magnetic metal particles, the insulating coating layers being in contact with one another; and an insulating resin disposed around the magnetic metal particles and the insulating coating layers.

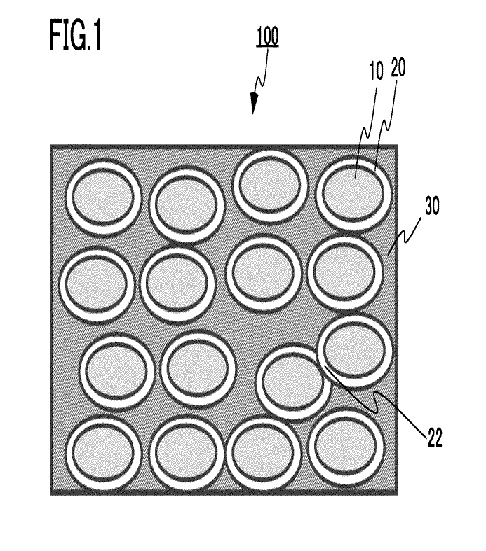

FIG. 1 is a schematic cross-sectional diagram of the composite material of the present embodiment.

Magnetic metal particles 10 contain at least one kind of magnetic metal selected from a first group consisting of iron (Fe), cobalt (Co) and nickel (Ni); at least one kind of non-magnetic metal selected from a second group consisting of magnesium (Mg), aluminum (Al), silicon (Si), calcium (Ca), zirconium (Zr), titanium (Ti), hafnium (Hf), zinc (Zn), manganese (Mn), barium (Ba), strontium (Sr), chromium (Cr), molybdenum (Mo), silver (Ag), gallium (Ga), scandium (Sc), vanadium (V), yttrium (Y), niobium (Nb), lead (Pb), copper (Cu), indium (In), tin (Sn) and rare earth elements; and at least one kind of additive metal selected from a third group consisting of boron (B), carbon (C), tantalum (Ta), tungsten (W), phosphorus (P), nitrogen (N) and gallium (Ga).

The magnetic metal is at least one kind of metal selected from the first group consisting of Fe (iron), Co (cobalt) and Ni (nickel). Regarding the magnetic metal, Fe-based alloys, Co-based alloys and FeCo-based alloys that can realize high saturation magnetization are particularly preferably used. Here, examples of the Fe-based alloys and Co-based alloys include a FeNi alloy, a FeMn alloy, a FeCu alloy, a FeMo alloy, a FeCr alloy, a CoNi alloy, a CoMn alloy, a CoCu alloy, a CoMo alloy, and a CoCr alloy, all of which contain Ni, Mn (manganese), Cu (copper), Mo (molybdenum) and Cr (chromium) as second components. Examples of the FeCo-based alloys include alloys containing Ni, Mn, Cu, Mo and Cr as second components. The aforementioned second components are components effective for increasing the magnetic permeability.

The non-magnetic metal is at least one kind of metal selected from the second group consisting of Mg (magnesium), Al (aluminum), Si (silicon), Ca (calcium), Zr (zirconium), Ti (titanium), Hf (hafnium), Zn (zinc), Mn (manganese), Ba (barium), Sr (strontium), Cr (chromium), Mo (molybdenum), Ag (silver), Ga (gallium), Sc (scandium), V (vanadium), Y (yttrium), Nb (niobium), Pb (lead), Cu (copper), In (indium), Sn (tin), and rare earth elements. Since these non-magnetic metals have small standard Gibbs energy of formation of oxides, and are susceptible to oxidation. Therefore, these non-magnetic metals are preferable from the viewpoint of the stability of the insulating properties of the insulating coating layer 20 that covers the magnetic metal particles 10. Among them, Al and Si may easily form solid solutions with Fe, Co and Ni, which are the main components of the magnetic metal particles 10, and are therefore preferable from the viewpoint of thermal stability. Meanwhile, the insulating coating layer 20 described above is preferably an oxide or a composite oxide containing one or more of the non-magnetic metals, which constitute one of the constituent components of the magnetic metal particles 10. Here, the composite oxide refers to an oxide containing two or more kinds of metal ions.

The additive metal is at least one kind of metal selected from the third group consisting of B (boron), C (carbon), Ta (tantalum), W (tungsten), P (phosphorus), N (nitrogen), and Ga (gallium). The additive metal can make the magnetic anisotropy higher by forming a solid solution with a magnetic metal. In a material having high magnetic anisotropy, the ferromagnetic resonance frequency becomes high. Here, at a frequency near the ferromagnetic resonance frequency, W (real part of magnetic permeability) of the magnetic material 100 is decreased, and μ″ (imaginary part of magnetic permeability) is increased. For that reason, a material that can be used in a high frequency band can be produced by adjusting the ferromagnetic resonance frequency to a higher frequency. Since C and N can easily form solid solutions with magnetic metal, C and N are particularly preferably used. Furthermore, it is preferable that the additive metal be included in an amount of from 0.001 atom % to 25 atom % relative to the total amount of the magnetic metal, the non-magnetic metal, and the additive metal. If the content is less than 0.001 atom %, the effects are not obtained, and if the content is more than 25 atom %, saturation magnetization of the magnetic metal particles 10 becomes too small.

It is preferable that at least two among the magnetic metal, the non-magnetic metal and the additive metal form a solid solution of each other. When a solid solution is formed, magnetic anisotropy can be effectively enhanced, and thereby, the high frequency magnetic characteristics and the mechanical characteristics can be enhanced. When a solid solution is not formed, the non-magnetic metal or the additive metal is segregated at the grain boundaries or the surface of the magnetic metal particles 10, and the magnetic anisotropy and mechanical characteristics cannot be effectively enhanced.

The magnetic metal particles 10 may be any of polycrystalline particles or single crystal particles; however, single crystal particles are preferred. When single crystal particles are used, since the axes of easy magnetization can be aligned when the particles are integrated, magnetic anisotropy can be controlled, and the high frequency characteristics can be enhanced.

The average particle size of the magnetic metal particles 10 is not particularly limited; however, the optimum value of the average particle size is determined by the frequency used. The losses caused by eddy currents become larger as the particle size is larger, and the coercive force also has dependency on the particle size. It is preferable to select a particle size which is optimal if the eddy current and the coercive force are considered. For example, although the coercive force is dependent on the material, since the coercive force has the maximum value at a particle size near approximately 20 nm, it is preferable to design the particle size to be smaller or larger than this value. However, if the particle size is larger, the eddy current loss becomes large; therefore, the use of the material at a high frequency is not preferable. A preferred average particle size of the magnetic metal particles 10 is, for example, from 10 nm to 20 nm.

The magnetic metal particles 10 may be spherical particles; however, flat particles or rod-shaped particles having large aspect ratios are preferred. If the aspect ratio is increased, shape-induced magnetic anisotropy can be imparted, the high frequency characteristics of magnetic permeability are enhanced, and also, the particles can be easily oriented by a magnetic field when a material is produced by integrating the particles. This is because the high frequency characteristics of the magnetic permeability are further enhanced if the particles are oriented. Also, when the aspect ratio becomes larger, the critical particle size that forms a single magnetic domain structure can be made larger, and thus the high frequency characteristics of magnetic permeability are not deteriorated even in large particles. For example, if the magnetic metal particles 10 are spherical in shape, the critical particle size that forms a single magnetic domain structure is about 50 nm; however, in the case of flat particles having a large aspect ratio, the critical particle size becomes larger. In general, since particles having a large particle size can be synthesized more easily, it is more advantageous if the aspect ratio is larger, from the viewpoint of production. In addition, if the aspect ratio is made larger, the packing ratio of the magnetic metal particles 10 can be made higher if a material is produced by integrating the particles, thereby the saturation magnetization per unit volume or per unit weight of the material can be made higher, and the magnetic permeability can also be increased. A preferred aspect ratio of the magnetic metal particles 10 is, for example, from 5 to 500.

The magnetic metal particles 10 may also be amorphous. The magnetic metal particles may be formed from a simple metal substance, or from an alloy, or may be formed from a mixed amorphous material with insulating substances such as oxides, nitrides or carbides.

The rate of change in the lattice constant of the magnetic metal particles 10 is ±1% or less with respect to the lattice constant obtained after a heat treatment at 1000° C. If the magnetic material 100 is heat treated at 1000° C., the magnetic metal particles 10 remain in a powdered form. Since the insulating resin 30 has been decomposed, the magnetic metal particles 10 that remain in a powdered form are no longer subject to the stress exerted by the insulating resin 30. Accordingly, the lattice constant of the magnetic metal particles 10 that remain in a powdered form is the lattice constant in a state without any processing strain that is exerted when the magnetic material 100 is formed. The fact that the rate of change in the lattice constant is ±1% or less implies that the strain applied to the magnetic metal particles 10 is small. Thus, it is implied that a magnetic material 100 having low coercive force and high magnetic permeability can be obtained. The atmosphere during the heat treatment is preferably a reducing atmosphere of H₂ gas, CO or the like, because magnetization is restored because of a reducing action. However, the atmosphere during the heat treatment may also be a vacuum or a noble gas atmosphere of Ar gas or the like. Meanwhile, it is also acceptable that after the heat treatment, other residues may be incorporated into the magnetic metal particles 10.

The lattice constant is measured by an X-ray diffraction (XRD) method. First, the lattice constant of the above-mentioned magnetic metal particles 10 that remain in a powdered form when heat treated at 1000° C., is measured by the powder X-ray diffraction method. The magnetic metal particles 10 remaining in a powdered form are mixed with a Si powder as a standard sample, the mixture is fixed by pressing in a holder for powder X-ray evaluation such that the surface to which X-radiation is irradiated becomes flat as much as possible. At this time, if there is a possibility for oxidation of the powder, it is preferable to cover the powder with, for example, a thin resin film so as to prevent the powder from being in contact with air. Next, X-radiation is irradiated to the powder, the reflection angle θ is determined from the reflection peak position, and the lattice constant d is determined from the formula: 2d sin θ=nλ. Here, n represents a constant, and λ represents the wavelength of X-radiation. Meanwhile, corrections based on the characteristics of the X-ray diffraction apparatus and the like may be appropriately applied. Also, it should be noted that if the fixation of the powder to the holder for powder X-ray evaluation is too strongly achieved, there is a risk that the lattice constant may change.

Regarding the lattice constant of the magnetic metal particles 10 in the magnetic material 100, in a case in which the magnetic material 100 can be pulverized, the magnetic material 100 is pulverized using, for example, a mortar to obtain a powder form, and then the lattice constant is measured by the powder X-ray diffraction method described above. Next, in a case in which it is difficult to pulverize the magnetic material 100, the insulating resin 30 is dissolved using, for example, an organic solvent, and the magnetic metal particles 10 are collected using a magnet and the like. Subsequently, measurement is made by the powder X-ray diffraction method. Meanwhile, in a case in which a layer for covering the surface of the magnetic material 100 is formed, a treatment similar to peeling of the layer for covering can be carried out. If it is difficult to dissolve the insulating resin 30, the magnetic metal particles 10 are exposed on the surface by cutting out a portion of the magnetic material 100, X-radiation is irradiated in a state in which a Si powder as a standard sample has been supported by rubbing the Si powder against the surface in the exposed area, and thus measurement is carried out.

The magnetic metal particles 10 of the present embodiment are not particularly limited; however, a magnetic metal composed of at least one kind or more of Fe, Co and Ni, is preferable. More preferred are magnetic metal particles 10 containing a non-magnetic metal and at least one of carbon and nitrogen, and the oxide coating layer covering the surface of the magnetic metal particles 10 is an oxide or a composite oxide containing one or more of the non-magnetic metals, which constitute one of the constituent components of the magnetic metal particles 10.

The contents of the non-magnetic metal, carbon and nitrogen contained in the magnetic metal particles 10 are all 20 atom % or less with respect to the magnetic metal. When the contents are more than or equal to that value, the saturation magnetization of the magnetic particles is decreased, which is not preferable.

The insulating coating layer 20 insulates and covers at least a portion of the magnetic metal particles 10. Thereby, the insulating properties of the magnetic material 100 are enhanced, and production of a magnetic material 100 reflecting the high magnetic permeability inherent in the magnetic metal particles 10 is enabled. It is preferable that the insulating coating layer 20 be composed of an oxide, a nitride or a carbide containing at least one kind of element selected from the first group, the second group and the third group described above, from the viewpoint that a stable insulating coating layer 20 can be formed more easily.

The thickness of the insulating coating layer 20 is not particularly limited, but a thickness of from 0.1 nm to 100 nm is preferred. If the thickness is less than 0.1 nm, since the oxidation resistance is insufficient, there is a possibility that there may occur a problem of oxidation proceeding as soon as the insulating coating layer is exposed to air, causing heat generation. Thus, handling of the magnetic metal particles 10 becomes difficult. Furthermore, if the thickness is 100 nm or more, when the magnetic material 100 is produced, the packing ratio of the magnetic metal particles 10 included in the magnetic material 100 is decreased, the saturation magnetization of the magnetic material 100 is decreased, and thus, the magnetic permeability is decreased, which is not preferable. The thickness of the insulating coating layer 20 that is stable to oxidation and is effective in preventing a decrease in magnetic permeability, is from 0.1 nm to 100 nm.

According to the present embodiment, the insulating coating layers 20 are in contact with one another, as in the case of the part 22 where the insulating coating layers are in contact. Thereby, a portion of the magnetic metal particles 10 having the insulating coating layer 20 are in an aggregated state. If the magnetic metal particles have this structure, lowering of the coercive force of the magnetic material 100 can be realized. The reason why the lowering of the coercive force can be realized as the insulating coating layers 20 are brought into contact with one another, is not clearly understood. However, it is speculated that during the operation of heat treatment carried out when the magnetic material 100 of the present embodiment is produced, the insulating resin 30 may become fluid, and during the course in which the magnetic metal particles 10 move irregularly as a result of the acquirement of fluidity, the interfacial distortion is decreased by aggregating a portion of the magnetic metal particles while decreasing the rate of change in the lattice constant, so that low coercive force is realized as neighboring magnetic metal particles 10 affect the magnetic interaction between the particles.

The insulating resin 30 is disposed around the magnetic metal particles 10 and the insulating coating layers 20. The insulating resin 30 is used in order to increase the insulating properties of the magnetic material 100. Specifically, a polyimide-based resin, a silicone resin, or a copolymer of these resins is used. However, the insulating resin is not limited to these resins, and other resins may also be used. It is preferable that the insulating resin 30 of the present embodiment be heat resistant.

The magnetic material 100 may contain inorganic materials such as an oxide, a nitride, and a carbide. Specific examples include oxides such as Al₂O₃ and SiO₂; nitrides such as AlN; and carbides such as SiC.

Meanwhile, in regard to the magnetic material 100 related to the present embodiment and the method for producing the magnetic material, the material structure can be determined (analyzed) by scanning electron microscopy (SEM) or transmission electron microscopy (TEM); the diffraction pattern (including the confirmation of solid solution) can be determined (analyzed) by TEM-diffraction or X-ray diffraction (XRD); and the classification and quantitative analysis of the constituent elements can be carried out by an inductively coupled plasma (ICP) emission analysis, a fluorescent X-ray analysis, an electron probe micro-analysis (EPMA), an energy dispersive X-ray fluorescence spectrometer (EDX), or the like. The average particle size of the magnetic metal particles 10 is determined by defining the average of the longest diagonal and the shortest diagonal of each of individual particles as the particle diameter by a TEM observation or a SEM observation, and determining the average of particle diameters. The coercive force is determined by measuring the coercive force using a vibrating sample magnetometer (VSM). The specific magnetic permeability is determined by analyzing a sample molded into a toroidal shape using an impedance analyzer.

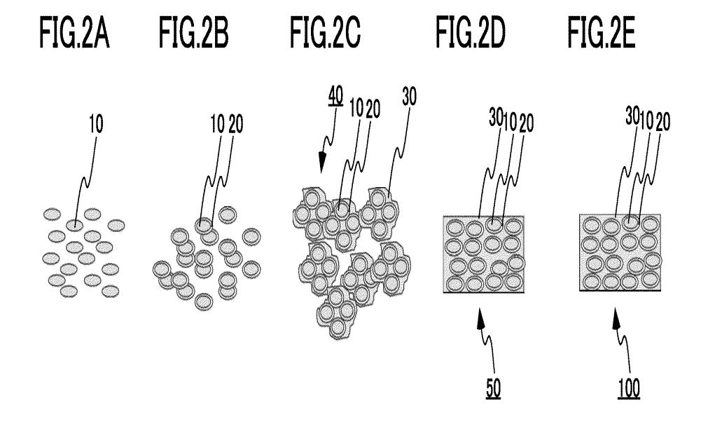

Next, the method for producing the magnetic material 100 of the present embodiment is described. FIGS. 2A to 2E are schematic diagrams of the method for producing the magnetic material 100 of the first embodiment. First, as shown in FIG. 2A, magnetic metal particles 10 are prepared. The method for producing the magnetic metal particles 10 is not particularly limited; however, for example, dry synthesis methods such as a high frequency induction thermal plasma method and a laser ablation method are preferably used. Furthermore, wet synthesis methods such as a co-precipitation method are also preferably used.

It is preferable that a coating of carbon or the like be provided on the surface of the synthesized magnetic metal particles 10. It is because the magnetic metal particles 10 are very highly active and undergo oxidation and combustion when brought into contact with air. However, when the magnetic metal particles are handled in an inert gas or a vacuum, or in a liquid which is less reactive, it is acceptable not to provide the magnetic metal particles with a coating of carbon or the like. Furthermore, for example, when carbon is coated, it is preferable to gasify and remove carbon by subjecting the carbon coating to heating and a reduction treatment. This is because residual carbon has electrical conductivity and is not suitable as an insulating material.

Next, as illustrated in FIG. 2B, an insulating coating layer 20 is formed on the surface of the magnetic metal particles 10. Here, the method for forming the insulating coating layer 20 is not particularly limited. For example, the insulating coating layer 20 can be preferably formed by oxidation based on natural oxidation or the like or a sol-gel method using tetraethoxysilane (TEOS) or polysilazane. Furthermore, the insulating coating layer 20 may also be formed by heat-treating the magnetic metal particles 10 and thereby oxidizing the surface. Furthermore, the insulating coating layer 20 may also be formed by supporting insulating fine particles of Al₂O₃ or the like on the surface of the magnetic metal particles 10. Furthermore, insulating coating layers 20 can be also formed by combining the methods described above, thereby obtaining a further firm insulating coating layer 20. The components of the insulating coating layer 20 are also not particularly limited; however, in general, techniques of coating a glass layer containing Si oxides, an oxide film containing Al oxides, a boron-based glass, or Al₂O₃ fine particles so as to mechanically embed the films or fine particles in the magnetic particle surface, are also known. Any insulating coating layer which has excellent heat resistance and high insulating properties and is capable of forming a thin and uniform coating can be preferably used.

Furthermore, it is preferable that the magnetic metal particles 10 be produced in a core-shell form. For example, it is preferable to form a coating layer containing Al₂O₃ by configuring an oxide coating film by allowing the magnetic metal particles to stand in, for example, an inert gas having a very small oxygen concentration, and to bring the coating layer into a relatively stable state. In addition to that, it is also acceptable to form a coating layer through nitridation or carbonization.

Next, as illustrated in FIG. 2C, magnetic metal particles 10 having an insulating coating layer 20 formed on the surface are dispersed in an insulating resin 30, and thus a dispersion mixture 40 is formed. Here, the method for forming the dispersion mixture 40 is not particularly limited; however, examples of the method include mortar mixing, ball mill mixing, three-roll mixing, and mixing by an agitated granulating machine. Furthermore, the insulating resin 30 thus prepared may also be an insulating resin precursor. In the case of a polyimide-based resin, for example, an N,N-dimethylacetamide solution of a silane-modified polyamic acid resin is preferably used as a precursor. Furthermore, for example, a silicone monomer or oligomer may also be used. The concentration of the insulating resin precursor is not particularly limited.

Next, as illustrated in FIG. 2D, the dispersion mixture 40 is molded, and a molded body 50 is formed. Here, the method for forming the molded body 50 is not particularly limited; however, a molded body forming method using a pressing apparatus such as a hydraulic pressing apparatus is preferably used. Furthermore, coating methods such as blowing by spraying and a doctor blade method can also be preferably used. Furthermore, a method for molding the molded body 50 by injection molding can also be preferably used. Meanwhile, the pressing pressure is usually from 0.5 to 3 t/cm², but the pressing pressure is not intended to be limited to this range.

Next, as illustrated in FIG. 2E, a magnetic material 100 is obtained by heat-treating the molded body 50 at a temperature higher than or equal to 300° C. but lower than the decomposition temperature of the insulating resin 30. In order to make the insulating resin 30 fluid during the course of the heat treatment, it is preferable to adjust the temperature to a temperature of 300° C. or higher. On the other hand, when the temperature is increased to a temperature higher than or equal to the decomposition temperature of the insulating resin 30, the magnetic material 100 is destroyed. Furthermore, the atmosphere of the heat treatment is preferably a reducing atmosphere of H₂ gas or CO because magnetization is restored by having a reducing action. However, a vacuum or a noble gas atmosphere of Ar gas or the like may be used.

Hereinafter, the operating effect of the present embodiment is described.

If the magnetic material 100 is used in component parts for high electric power consumption such as an inductor element for transformer, it is preferable to decrease the hysteresis loss of the magnetic material 100. Here, such a hysteresis loss is dependent on the coercive force of the magnetic metal particles 10.

In regard to the magnetic material 100, when the molded body 50 is molded, internal stress is exerted to the magnetic metal particles 10. At this time, strain is exerted to the magnetic metal particles 10, and the coercive force is increased. Due to an increase in such coercive force, the hysteresis loss of the magnetic material 100 is increased, and the electric power loss of an electric power component part is increased. Furthermore, the magnetic permeability is decreased. The reason why the magnetic permeability is decreased is that magnetic anisotropy is increased due to strain.

When a heat treatment is carried out at a temperature of 300° C. or higher, the internal stress is relieved, and the intrinsic high magnetic permeability can be obtained. However, conventional resins are decomposed at this temperature, it is not preferable for producing large electric power component parts such as inductor elements for transformers. Furthermore, even if a heat resistant resin is used, when the magnetic metal particles 10 do not have a coating layer, the magnetic metal particles 10 are aggregated and have decreased insulating properties.

According to the present embodiment, when the magnetic metal particles 10 that can withstand mounting in large electric power component parts are coated to a high extent, and the coercive force is suppressed, a magnetic material 100 which has small losses and can give high magnetic permeability at a high frequency is provided.

### Second Embodiment

The magnetic material of the present embodiment differs from the magnetic material of the first embodiment from the viewpoint that at least a portion of the insulating coating layer is disposed on the surface of the magnetic material. Regarding any matters overlapping with the matters of the first embodiment, no description will be repeated herein.

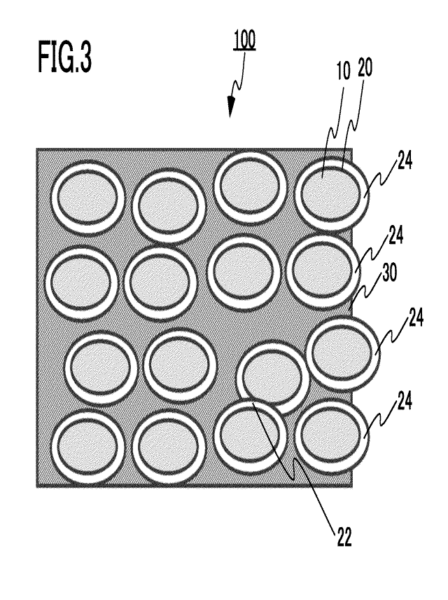

FIG. 3 is a schematic cross-sectional diagram of the magnetic material 100 of the present embodiment. In the magnetic material 100 of the present embodiment, a portion of the insulating coating layer 20 is disposed in the form of, for example, protrusions 24 on the surface of the magnetic material 100. Such a structure is a structure that is preferably formed when a mixture of magnetic metal particles 10 having a high aspect ratio and an insulating resin 30 is heat-treated. Since the insulating coating layer has a concavo-convex structure on the surface, the adhesive strength is increased when the magnetic material 100 is coating-treated, which is preferable. Furthermore, it is also possible to use the magnetic material after flattening the concavo-convex structure made by the protrusions 24, by polishing the surface of the magnetic material 100. In this case, a cross-sectional structure of the magnetic metal particles 10 and the insulating coating layer 20 may be observed at the surface of the material.

According to the magnetic material of the present embodiment, there is provided a magnetic material having increased adhesive strength when magnetic material is coating-treated.

### Third Embodiment

The magnetic material of the present embodiment includes a plurality of particle aggregates including a plurality of magnetic metal nanoparticles having a rate of change in the lattice constant of ±1% or less with respect to the lattice constant obtained after a heat treatment at 1000° C.; a plurality of interstitial phases disposed around the magnetic metal nanoparticles; and a plurality of insulating coating layers insulating and coating at least a portion of the interstitial phases and being in contact with one another; and an insulating resin disposed around the particle aggregates. Here, further descriptions will not be repeated on any matters overlapping with the matters of the first and second embodiments.

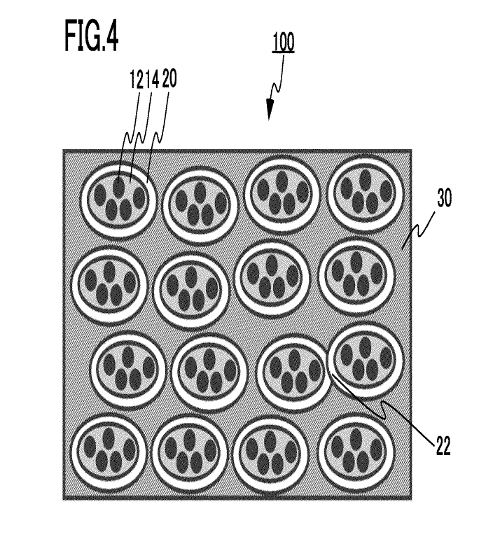

FIG. 4 is a schematic cross-sectional diagram of the magnetic material of the present embodiment.

The particle size of the magnetic metal nanoparticles 12 is preferably from 1 nm to 200 nm as an average particle size, and among others, the particle size is particularly preferably from 10 nm to 50 nm. If the particle size is less than 10 nm, superparamagnetism occurs, and the amount of magnetic flux becomes insufficient. On the other hand, if the particle size is large, the eddy current loss becomes large in a high frequency region, and the magnetic characteristics may be deteriorated in the intended high frequency region. Also, it is more stable in terms of energy to adopt a multi-magnetic domain structure rather than a single magnetic domain structure. At this time, the high frequency characteristics of the magnetic permeability of the multi-magnetic domain structure become poorer than the high frequency characteristics of the magnetic permeability of the single magnetic domain structure. Therefore, it is preferable to allow the particles to exist as particles having a single magnetic domain structure. Since the critical particle size for maintaining the single magnetic domain structure is about 50 nm or less, it is more desirable to adjust the particle size to 50 nm or less. Thus, it is preferable that the average particle size of the magnetic metal nanoparticles 12 be adjusted to from 1 nm to 200 nm, and among others, particularly preferably in the range of from 10 nm to 50 nm.

Since other matters on the magnetic metal nanoparticles 12 overlap with the matters on the magnetic metal particles 10 of the first embodiment, description on these matters will not be repeated here.

It is preferable that the particle aggregates 26 have a shape having an average short dimension of from 10 nm to 2 μm and an average aspect ratio of 5 or more. If the average short dimension is less than 10 nm, the particle size becomes less than 10 nm as described above, and the amount of magnetic flux is insufficient. If the average short dimension is 2 μm or more, losses become large because an eddy current occurs. When the aspect ratio is large, since shape-induced magnetic anisotropy is imparted, the magnetic particles can be easily oriented by a magnetic field when a desired magnetic material is produced by integrating the magnetic particles.

It is desirable that the interstitial phase 14 contain at least one or more magnetic metals selected from Fe, Co and Ni. Thereby, the adhesiveness between the magnetic metal nanoparticles 12 and the interstitial phase 14 is enhanced, and thermal stability and oxidation resistance are enhanced.

It is desirable that the interstitial phase 14 contain at least one or more non-magnetic metals selected from Mg, Al, Si, Ca, Zr, Ti, Hf, Zn, Mn, Ba, Sr, Cr, Mo, Ag, Ga, Sc, V, Y, Nb, Pb, Cu, In, Sn, and rare earth elements. Among them, it is preferable that the interstitial phase 14 contain at least one or more non-magnetic metals selected from Mg, Al, Si, Ca, Zr, Ti, Hf, rare earth elements, Ba, and Sr. These non-magnetic metals can increase the resistance of the magnetic metal nanoparticles 12, and can increase thermal stability and oxidation resistance, which is preferable.

It is desirable that the interstitial phase 14 be a metal, a semiconductor, an oxide, a nitride, a carbide, or a fluoride, all of them containing the non-magnetic metals listed above, and particularly from the viewpoint that high thermal stability and high oxidation resistance can be realized, it is more desirable that the interstitial phase be an oxide, a nitride or a carbide.

It is desirable that the interstitial phase 14 have higher resistance compared with the magnetic metal nanoparticles 12, from the viewpoint of reducing the losses caused by an eddy current and the like.

Regarding the interstitial phase 14, when the magnetic metal nanoparticles 12 contain at least one or more non-magnetic metals selected from Mg, Al, Si, Ca, Zr, Ti, Hf, Zn, Mn, Ba, Sr, Cr, Mo, Ag, Ga, Sc, V, Y, Nb, Pb, Cu, In, Sn, and rare earth elements, it is desirable that the interstitial phase 14 contain at least one of those non-magnetic metals. Thereby, the adhesiveness between the magnetic metal nanoparticles 12 and the interstitial phase 14 can be increased, and the thermal stability and oxidation resistance of the magnetic material 100 can be enhanced.

The production method of the present embodiment will be described. First, particles containing a magnetic metal are formed. Here, the method for forming particles containing a magnetic metal is similar to the method for preparing the magnetic metal particles 10 described above. Here, it is preferable to have an insulating film such as an oxide film formed on the surface of the particles containing a magnetic metal, for the purpose of protecting the particles containing a magnetic metal.

Next, the particles containing a magnetic metal are treated by pulverization with a planetary ball mill, a ball mill or the like, and the particles are collected and then heat treated in, for example, a reducing atmosphere. Thus, particles having a heterogranular structure in which magnetic metal nanoparticles 12 are dispersed in an interstitial phase 14, are produced.

Next, an insulating coating layer 20 is formed by the method described above. The subsequent processes of the production method are similar to those of the method for producing a magnetic material 100 of the first embodiment.

According to the magnetic material of the present embodiment, when magnetic metal particles 10 which can withstand mounting in large electric power component parts are coated to a high extent, and the coercive force is suppressed, a magnetic material which has small losses and can give high magnetic permeability at a high frequency is provided.

### Fourth Embodiment

The present embodiment is an inductor element characterized by using the magnetic material related to the first, second or third embodiment. Regarding any matters overlapping with the matters of the first, second and third embodiments, further description will not be given here.

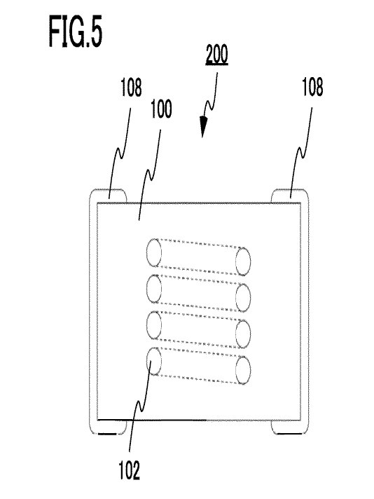

FIG. 5 is a schematic diagram of a chip inductor element 200 of the present embodiment. A coil 102 is disposed inside the magnetic material 100. The two ends of the coil 102 are respectively connected to two electrodes 108.

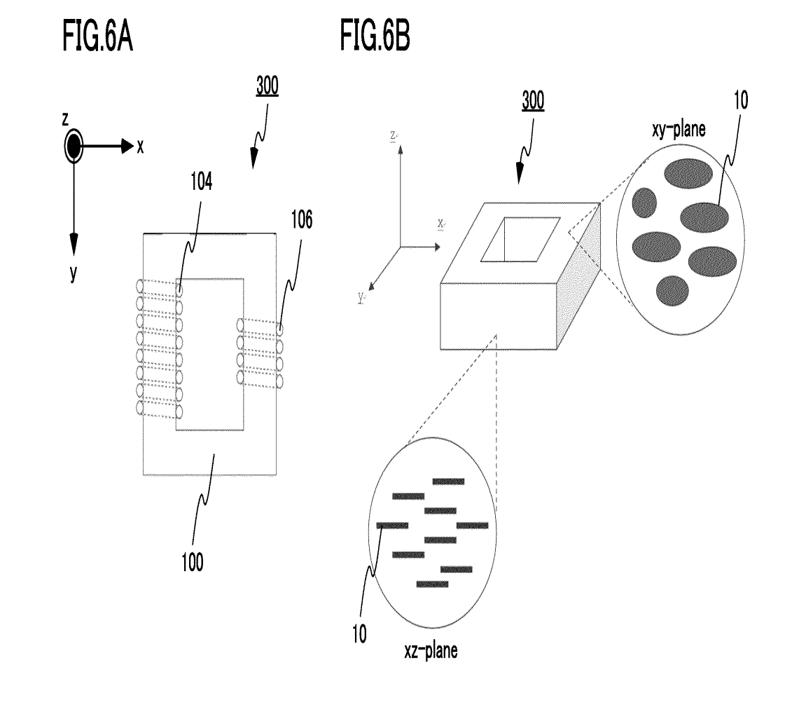

FIGS. 6A and 6B are schematic diagrams of an inductor element 300 for transformers of the present embodiment. The inductor element 200 for transformers has a form in which a first coil 104 and a second coil 106 are wound around the magnetic material 100, as illustrated in FIG. 6A. The two ends of the first coil 104 and the two ends of the second coil 106 may be connected to electrodes that are not shown in the diagram.

FIG. 6B illustrates the method for orienting the flat surfaces of the magnetic metal particles 10 in the inductor element 300 for transformers of the present embodiment. It is preferable that the flat surfaces of the magnetic metal particles 10 be oriented in the xy-plane, as shown in FIG. 6B. It is because the magnetic permeability of the magnetic material in the axial direction of the first coil 104 and the axial direction of the second coil 106 can be further increased thereby.

According to the present embodiment, an inductor element which has small losses and can give high magnetic permeability at a high frequency, is provided.

### EXAMPLES

Hereinafter, Examples will be described in more detail by way of a comparison with Comparative Examples.

### Example 1

FeNiSi particles having an average particle size of 40 nm were treated with a planetary ball mill for 20 minutes, and these particles are collected. Subsequently, the FeNiSi particles were subjected to an insulating coating treatment with tetraethyl orthosilicate (TEOS), followed by drying, and the particles were mixed in a mortar with a dimethylacetamide (DMA) solution of a polyimide resin precursor and were granulated. Subsequently, these granules were molded at 1 t/cm², and thereby, a magnetic material precursor having a diameter of an external form of 7 mmφ, an inner diameter of 4 mmφ, and a thickness of 2 mm was obtained. Furthermore, this magnetic material precursor was heat treated at 400° C. in hydrogen, and thereby a magnetic material 100 was obtained. The coercive force and magnetic permeability of this magnetic material 100 were measured, and the coercive force was 15 Oe, while the specific magnetic permeability was 10 at 1 MHz. Furthermore, this magnetic material 100 was pulverized with a mortar, Si was used as a standard sample, and thus the lattice constant dm of the magnetic metal particles 10 was measured. Furthermore, this magnetic material 100 was heat treated at 1000° C. in hydrogen, the resin was decomposed, and then the lattice constant ds was measured. The rate of change of the lattice constant was −0.85%. Meanwhile, the rate of change was calculated by the formula: (dm−ds)/ds.

### Example 2

A magnetic material 100 was produced by the same technique as that used in Example 1, using FeCoSi particles having an average particle size of 110 nm, and the magnetic material was evaluated. The coercive force was 29 Oe, and the specific magnetic permeability was 10. Furthermore, the rate of change of the lattice constant of the magnetic metal particles 10 in this case was −0.064%.

### Example 3

FeNiAl particles having an average particle size of 45 nm were treated with a planetary ball mill for 120 minutes, and these particles are collected. Subsequently, the FeNiAl particles were subjected to an insulating coating treatment with TEOS, followed by drying, and the particles were mixed in a mortar with a silicone resin and granulated. Thus, a composite powder was produced. These granules were molded at 3 t/cm², and thereby, a magnetic material precursor having an external form of 7 mmφ, an inner diameter of 4 mmφ, and a thickness of 2 mm was obtained. Furthermore, this magnetic material precursor was heat treated at 350° C. in hydrogen, and thereby a magnetic material 100 was obtained. The coercive force and magnetic permeability of this magnetic material were measured, and the coercive force was 30 Oe, while the specific magnetic permeability was 7. Furthermore, the rate of change of the lattice constant of the magnetic metal particles 10 in this case was −0.23%.

### Example 4

A composite powder was produced by subjecting FeSiCr particles having a thickness of 80 nm and an aspect ratio of 220 as flat-shaped particles to an insulating coating treatment with TEOS, followed by drying, mixing in a mortar with a silicone resin, and granulation. This composite powder was molded at 3 t/cm², and thereby, a magnetic material precursor having an external form of 7 mmφ, an inner diameter of 4 mmφ, and a thickness of 2 mm was obtained. Furthermore, this was heat treated at 350° C. in hydrogen, and thus a magnetic material 100 was obtained. The coercive force and magnetic permeability of this magnetic material were measured, and the coercive force was 10 Oe, while the specific magnetic permeability was 40. Furthermore, the rate of change of the lattice constant of the magnetic metal particles 10 in this case was 0.12%. Furthermore, the content of Cr was approximately 1 atom % with respect to FeSi.

### Example 5

Fe particles having an average particle size of about 1 μm and 1 wt % of Al₂O₃ fine particles were treated with a ball mill for 20 minutes, and the particles were subjected to an insulating coating treatment. Subsequently, these particles were collected, dried, mixed in a mortar with a DMA solution of a polyimide resin precursor, and granulated, and thus a composite powder was produced. This composite powder was molded at 3 t/cm², and thereby a magnetic material precursor having an external form of 7 mmφ, an inner diameter of 4 mmφ, and a thickness of 2 mm was obtained. Furthermore, this magnetic material precursor was heat treated at 400° C. in hydrogen, and thus a magnetic material 100 was obtained. The coercive force and magnetic permeability of this magnetic material were measured, and the coercive force was 5 Oe, while the specific magnetic permeability was 20. Furthermore, the rate of change of the lattice constant of the magnetic metal particles 10 in this case was 0.10%.

### Example 6

A magnetic material 100 was produced by forming a coating layer by the same method as that used in Example 5, except that ZrO₂ fine particles were used instead of Al₂O₃. The coercive force of the magnetic material 100 was 7 Oe, and the specific magnetic permeability was 15. Furthermore, the rate of change of the lattice constant of the magnetic metal particles 10 in this case was 0.57%.

### Example 7

An inductor was produced by winding a conductive wire around the magnetic material 100 produced in Example 1. A loss was measured, and the loss was 0.2 W/cc at 1 MHz. This was used in a state of being mounted in a power supply base, and the inductor was usable because heat generation occurred at or below 50° C.

### Comparative Example 1

A composite powder was produced by the same method as that used in Example 1, except that an acetone solution of polyvinyl butyral was used instead of the DMA solution of a polyimide resin precursor. This composite powder was molded at 1 t/cm², and thereby, a magnetic material precursor having an external form of 7 mmφ, an inner diameter of 4 mmφ, and a thickness of 2 mm was obtained. Furthermore, when this magnetic material precursor was heat treated at 400° C. in hydrogen, the magnetic material 100 was disintegrated. Thus, a magnetic material 100 was not obtained.

### Comparative Example 2

A magnetic material 100 was produced by the same method as that used in Example 1, except that the magnetic metal particles 10 were not coated. The coercive force was 15 Oe, but the electrical resistance was small, and a short circuit occurred. Thus, the specific magnetic permeability could not be evaluated at 1 MHz.

### Comparative Example 3

A magnetic material 100 was produced by producing a magnetic material precursor in the same manner as in Example 3, and then heat-treating the magnetic material precursor at 250° C. in hydrogen. The coercive force was 80 Oe, and the specific magnetic permeability was 5.

### Comparative Example 4

A magnetic material 100 was produced by the same method as that used in Comparative Example 1, except that no heat treatment was carried out. The coercive force was 110 Oe, and the specific magnetic permeability was 4.

### Comparative Example 5

An inductor was produced using the magnetic material 100 of Comparative Example 4, and the loss was 2 W/cc. This was used in a state of being mounted in a power supply base, and the magnetic material could not be used because heat generation occurred up to 80° C.

### Comparative Example 6

A magnetic material was produced in the same manner as in Example 1, except that the treatment conditions for planetary ball milling were changed. The insulating coating layers 20 were not in contact with one another, and no aggregation of the magnetic metal particles 10 occurred. The coercive force was 50 Oe, and the specific magnetic permeability was 5.

### Comparative Example 7

A magnetic material was produced in the same manner as in Example 1, except that the treatment conditions for planetary ball milling were changed. The rate of change of the lattice constant was −1.2%, the coercive force was 120 Oe, and the specific magnetic permeability was 4.

### Comparative Example 8

A magnetic material was produced in the same manner as in Example 1, except that the treatment conditions for planetary ball milling were changed. The rate of change of the lattice constant was +1.1%, the coercive force was 70 Oe, and the specific magnetic permeability was 4.

### Comparative Example 9

A magnetic material was produced in the same manner as in Example 1, except that the heat treatment temperature was 500° C. However, since the heat treatment temperature was higher than or equal to the decomposition temperature of the insulating resin 30, the insulating resin 30 was thermally decomposed.

The results of some Examples and some Comparative Examples related to the rate of change of the lattice constant are summarized in Table 1.

TABLE 1

| | Rate of | | |
|---|---|---|---|
| | change of | Coercive | Specific magnetic |
| | lattice constant | force (Oe) | permeability |
| Comparative Example 7 | −1.2% | 120 | 4 |
| Example 1 | −0.85% | 15 | 10 |
| Example 3 | −0.23% | 30 | 7 |
| Example 2 | −0.064% | 29 | 10 |
| Example 5 | +0.10% | 5 | 20 |
| Example 4 | +0.12% | 10 | 40 |
| Example 6 | +0.57% | 7 | 15 |
| Comparative Example 8 | +1.1% | 70 | 4 |

As is obvious from Table 1, the rate of change of the lattice constant was ±1% or less with respect to the lattice constant obtained after a heat treatment at 1000° C., and satisfactory coercive force and specific magnetic permeability were obtained.

The results for some Examples and some Comparative Examples related to the heat treatment temperature are summarized in Table 2.

TABLE 2

| | Heat treatment | Coercive | Specific magnetic |
|---|---|---|---|
| | temperature (° C.) | force (Oe) | permeability |
| Comparative | No heat treatment | 110 | 4 |
| Example 4 | | | |
| Comparative | 250 | 80 | 5 |
| Example 3 | | | |
| Example 3 | 350 | 30 | 7 |
| Example 4 | 350 | 10 | 40 |
| Example 1 | 400 | 15 | 10 |
| Example 5 | 400 | 5 | 20 |
| Comparative | 500 | Resin was | Resin was decomposed |
| Example 9 | | decomposed | |

As is obvious from Table 2, the heat treatment temperature was a temperature higher than or equal to 300° C. but lower than the decomposition temperature of the insulating resin 30, and satisfactory coercive force and specific magnetic permeability were obtained.

Examples 4, 5 and 6 represent the results for magnetic materials 100 obtained using magnetic metal particles 10, and others represent the results for magnetic materials 100 obtained using magnetic metal nanoparticles 12.

According to the magnetic material of at least one embodiment described above, when the magnetic material includes magnetic metal particles having a rate of change of the lattice constant of ±1% or less with respect to the lattice constant obtained after a heat treatment at 1000° C.; insulating coating layers insulating and covering at least a portion of magnetic metal particles and being in contact with one another; and an insulating resin disposed around the magnetic metal particles and the insulating coating layers, the coercive force is made smaller, and thus a magnetic material which has small losses and can give high magnetic permeability at a high frequency can be provided.

While certain embodiments have been described, these embodiments have been presented by way of example only, and are not intended to limit the scope of the inventions. Indeed, a magnetic material, a method for producing a magnetic material, and an inductor element described herein may be embodied in a variety of other forms; furthermore, various omissions, substitutions and changes in the form of the devices and methods described herein may be made without departing from the spirit of the inventions. The accompanying claims and their equivalents are intended to cover such forms or modifications as would fall within the scope and spirit of the inventions.

What is claimed is:

1. A magnetic material comprising:
a plurality of magnetic metal particles having a rate of change in the lattice constant of ±1% or less with respect to the lattice constant obtained after a heat treatment at 1000° C.;
a plurality of insulating coating layers insulating and covering at least a portion of the magnetic metal particles, the insulating coating layers being in contact with one another; and
an insulating resin disposed around the magnetic metal particles and the insulating coating layers.

2. The magnetic material according to claim 1, wherein the magnetic metal particles contain at least one kind of magnetic metal selected from a first group consisting of iron (Fe), cobalt (Co) and nickel (Ni).

3. The magnetic material according to claim 1, wherein the magnetic metal particles further contain at least one kind of non-magnetic metal selected from a second group consisting of magnesium (Mg), aluminum (Al), silicon (Si), calcium (Ca), zirconium (Zr), titanium (Ti), hafnium (Hf), zinc (Zn), manganese (Mn), barium (Ba), strontium (Sr), chromium (Cr), molybdenum (Mo), silver (Ag), gallium (Ga), scandium (Sc), vanadium (V), yttrium (Y), niobium (Nb), lead (Pb), copper (Cu), indium (In), tin (Sn), and rare earth elements.

4. The magnetic material according to claim 1, wherein the magnetic metal particles further contain at least one kind of additive metal selected from a third group consisting of boron (B), carbon (C), tantalum (Ta), tungsten (W), phosphorus (P), nitrogen (N), and gallium (Ga),
the additive metal included in an amount of from 0.001 atom % to 25 atom % relative to the total amount of the magnetic metal, the non-magnetic metal, and the additive metal.

5. The magnetic material according to claim 1, wherein the insulating coating layer is an oxide, a nitride or a carbide,
the oxide, the nitride or the carbide containing at least one kind of element selected from the first group, the second group, and the third group.

6. The magnetic material according to claim 1, wherein at least a portion of the insulating coating layer is disposed on the surface of the magnetic material.

7. An inductor element using the magnetic material according to claim 1.

8. A method for producing a magnetic material, the method comprising:
preparing a plurality of magnetic metal particles;
forming a plurality of insulating coating layers on the surface of the magnetic metal particles;
dispersing the magnetic metal particles having the insulating coating layers formed on the surface, in an insulating resin, and thereby forming a dispersion mixture;
molding the dispersion mixture, and thereby forming a molded body; and
heat-treating the molded body at a temperature higher than or equal to 300° C. but lower than the decomposition temperature of the insulating resin.

9. A magnetic material comprising:
a plurality of particle aggregates including
a plurality of magnetic metal nanoparticles having a rate of change in the lattice constant of ±1% or less with respect to the lattice constant obtained after a heat treatment at 1000° C.;
a plurality of interstitial phases disposed around the magnetic metal nanoparticles; and
a plurality of insulating coating layers insulating and coating at least a portion of the interstitial phases and being in contact with one another; and
an insulating resin disposed around the particle aggregates.

10. The magnetic material according to claim 9, wherein the magnetic metal nanoparticles contain at least one kind of magnetic metal selected from a first group consisting of Fe, Co and Ni.

11. The magnetic material according to claim 9, wherein the magnetic metal nanoparticles further contain at least one kind of non-magnetic metal selected from a second group consisting of Mg, Al, Si, Ca, Zr, Ti, Hf, Zn, Mn, Ba, Sr, Cr, Mo, Ag, Ga, Sc, V, Y, Nb, Pb, Cu, In, Sn, and rare earth elements.

12. The magnetic material according to claim 9, wherein the magnetic metal nanoparticles further contain at least one kind of additive metal selected from a third group consisting of B, C, Ta, W, P, N and Ga,
the additive metal included in an amount of from 0.001 atom % to 25 atom % relative to the total amount of the magnetic metal, the non-magnetic metal, and the additive metal.

13. The magnetic material according to claim 9, wherein the insulating coating layer is an oxide, a nitride, or a carbide,
the oxide, the nitride or the carbide containing at least one kind of element selected from the first group, the second group, and the third group.

14. The magnetic material according to claim 9, wherein the magnetic metal nanoparticles have an average particle size of from 1 nm to 200 nm, and the particle aggregates have an average short dimension of from 10 nm to 2 μm and an average aspect ratio of 5 or more.

15. The magnetic material according to claim 9, wherein at least a portion of the insulating coating layer is disposed on the surface of the magnetic material.

16. An inductor element using the magnetic material according to claim 9.
